(19) United States
(12) Patent Application Publication
(10) Pub. No.: US 2026/0110321 A1
(43) Pub. Date: Apr. 23, 2026

(54) Automatic Interlocking Retention Element

(71) Applicant: Illinois Tool Works Inc., Glenview, IL (US)

(72) Inventor: Joel R. Lee, Peotone, IL (US)

(21) Appl. No.: 19/358,107

(22) Filed: Oct. 14, 2025

Related U.S. Application Data
(60) Provisional application No. 63/709,582, filed on Oct. 21, 2024.

(51) Int. Cl. F16B 21/08; F16B 5/06; F16B 41/00

(52) U.S. Cl. CPC F16B 21/084; F16B 5/065; F16B 41/002

(57) ABSTRACT

Described is a fastener assembly configured to fasten a first component to a second component. The fastener assembly having a pin, a retainer, and a cap. The cap is coupled to the retainer via a strap and alternates between an open position and a closed position to secure the first component. The retainer has a body portion, a retainer body portion, and a fastener to engage the component opening. The retainer defines a passageway to receive the shank and the fastener receives a distal end of the shank. The cap defines an opening to receive and engage at least a portion of the body portion in the closed position.

### RELATED APPLICATION

The present application claims priority to U.S. Provisional Patent Application No. 63/709,582, filed Oct. 21, 2024, and entitled “Automatic Interlocking Retention Element,” which is hereby incorporated by reference in its entirety.

### BACKGROUND

Fasteners may be used to secure components together. In some examples, a fastener can be used to secure dissimilar materials, such as a soft object (e.g., cloth, foam, fabric, etc.) to a rigid object (e.g., metal, plastic, wood, etc.). Fasteners can be manufactured as a single-component fastener (e.g., individual nuts, bolts, anchors, and rivets) or as a multi-component fastener. When a multi-component fastener is provided in a loose configuration, the components can become lost or misplaced if the components become separated from one another.

Therefore, a multi-component fastener can be provided where the various components are affixed or tethered to one another. Commonly owned U.S. Patent Pub. No. 2020/0224697, for example, describes a tree fastener assembly having a cap, a body, and a strap that connects the cap with the body. While existing tethered multi-component fastener mitigate the risk of component loss during assembly, they can be more difficult to service and reuse without damage or affecting performance of the assembly fastener.

In light of the above, a need exists for a fastener assembly where various components of the fastener assembly are affixed or tethered to one another and a fastener assembly can be serviced or reused while preserving performance of the fastener assembly.

### SUMMARY

The present disclosure relates generally to an improved fastener, substantially as illustrated by and described in connection with at least one of the figures, as set forth more completely in the claims. More specifically, the present disclosure relates to a fastener assembly for fastening a soft object to the rigid object.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective view of an edge-fold system with an interlocking fastener in a closed position (installed position) in accordance with aspects of the present disclosure.

FIG. 1b illustrates a perspective cross-sectional view of the edge-fold system taken along cut-line B-B of FIG. 1a.

FIG. 1c illustrates a perspective cross-sectional view of the edge-fold system taken along cut-line A-A of FIG. 1a.

FIG. 1d illustrates a perspective cross-sectional view of the edge-fold system taken along cut-line D-D of FIG. 1a.

FIG. 1e illustrates a perspective cross-sectional assembly view of the edge-fold system taken along cut-line A-A of FIG. 1a.

FIG. 1f illustrates a perspective cross-sectional assembled view of the edge-fold system taken along cut-line A-A of FIG. 1a.

FIG. 1g illustrates a perspective cross-sectional assembly view of the edge-fold system taken along cut-line B-B of FIG. 1a.

FIG. 1h illustrates a perspective cross-sectional assembled view of the edge-fold system taken along cut-line B-B of FIG. 1a.

FIG. 2a illustrates a perspective view of an interlocking fastener in an open position (shipped position).

FIG. 2b illustrates a perspective cross-sectional view of the interlocking fastener in the open position (shipped position) taken along cut-line C-C of FIG. 2a.

FIG. 2c illustrates a perspective cross-sectional view of the interlocking fastener in the open position (shipped position) taken along cut-line E-E of FIG. 2a.

FIGS. 2d and 2e illustrate, respectively, top and bottom plan views of the interlocking fastener in the open position.

FIGS. 2f and 2g illustrate, respectively, first and second side elevation views of the interlocking fastener in the open position.

FIGS. 2h and 2i illustrate, respectively, third and fourth side elevation views of the interlocking fastener in the open position.

FIGS. 3a through 3c illustrate side elevational views of the edge-fold system during different stages of assembly.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

Fasteners vary in size and shape. In some cases, fasteners can be the same shape, but will vary in size. While fasteners are most often associated with creating non-permanent joints. They are also employed in numerous other functions that may require a more permanent fixture. Therefore, the following disclosure should not be limited to fasteners used in non-permanent joints, but rather would be applicable to fastener used in any situation to couple two or more objects.

In one example, an interlocking fastener comprises: a retainer portion defining a passageway extending along a longitudinal axis; and a fastener portion including a shaft extending along the longitudinal axis and a pin feature at a distal end of the shaft, wherein the pin feature is configured to snap into the retainer portion when the pin feature and the retainer portion are moved toward one another linearly along the longitudinal axis, and wherein the pin feature is configured to be released from the retainer portion when the pin feature is urged transversely relative to the longitudinal axis to disengage the pin feature from the retainer portion.

In another example, an interlocking fastener for securing a first component to a second component comprises: a retainer defining a passageway having a longitudinal axis and including a retainer body portion and a fastener portion, wherein the fastener portion comprises a pair of resilient retention legs extending from the retainer body portion and joined at distal ends by a leading end structure, and wherein each of the retention legs includes an outer retention feature and an inner bulbous portion; a post extending from the leading end structure toward the retainer body portion and between the pair of resilient retention legs, wherein the post includes one or more buttress features configured to engage the inner bulbous portions of the retention legs; and a pin feature positioned at a distal end of the post and configured to snap into the retainer body portion.

In some examples, the retainer portion includes one or more plane features or recesses configured to receive and retain corresponding head ledges formed on the pin feature when snapped together.

In some examples, urging the pin feature transversely relative to the longitudinal axis allows the head ledges to clear the plane features, thereby permitting the shaft to be withdrawn from the retainer portion.

In some examples, the fastener portion further comprises a pair of retention legs, wherein the shaft extends between the pair of retention legs.

In some examples, movement of the retainer portion and the fastener portion toward one another along the longitudinal axis causes one or more buttress features on the shaft to cam against the retention legs to urge the retention legs radially outward from the longitudinal axis.

In some examples, the fastener portion further comprises a contact bar configured to engage a surface of a component during installation to facilitate relative movement between the shaft and the retainer portion.

In some examples, the pin feature includes one or more head ledges configured to cooperatively retain the post in a locked position within the retainer.

In some examples, the pin feature is configured to translate along the longitudinal axis to extend into and engage a feature in the passageway.

In some examples, the feature is a plane feature defined by the retainer body portion.

In some examples, urging the pin feature transversely relative to the longitudinal axis releases the head ledges from the plane features, thus disengaging the pin feature from the retainer body portion.

In some examples, movement of the post and the retainer body portion toward one another along the longitudinal axis causes the buttress features to cam against the inner bulbous portions to urge the retention legs radially outward from the longitudinal axis into engagement with the second component.

In some examples, movement of the post and the retainer body portion away from one another along the longitudinal axis allows the retention legs to disengage the second component.

In some examples, the interlocking fastener further comprises: a cap defining a cap opening and having a plurality of locking tabs configured to engage a locking feature on the retainer; and a tether joining the cap to the retainer, the tether comprising at least one living hinge and one or more link portions, wherein the cap is configured to flex via the tether to move relative to the retainer between an open position and a closed position, and wherein, in the closed position, the locking tabs engage the locking feature to secure the first component between a shelf formed on the retainer and an underside of the cap.

In some examples, the interlocking fastener further comprises: a contact bar is generally perpendicular to the longitudinal axis and configured to abut the second component opening during assembly to move the post and the retainer body portion toward one another along the longitudinal axis.

Existing fastening solutions often lack the ability to be serviced and reused in both through-hole and blind-hole applications without loss of performance or retention force. The disclosed interlocking fastener addresses these limitations by providing a controlled, two-stage installation and removal mechanism. The interlocking fastener enables direct linear installation that rigidly locks the assembly in place, followed by damage-free linear removal without requiring any rotational or screw-type motion. This configuration allows the fastener to be reused multiple times while maintaining consistent locking performance and material integrity.

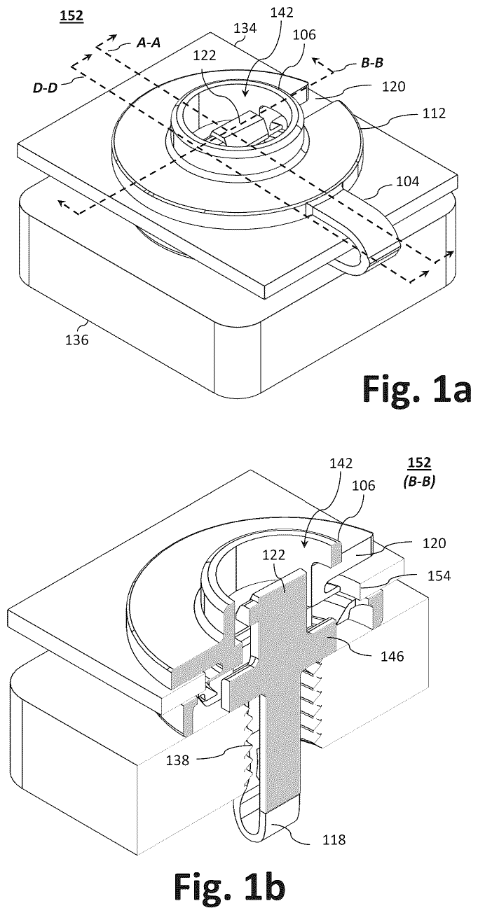

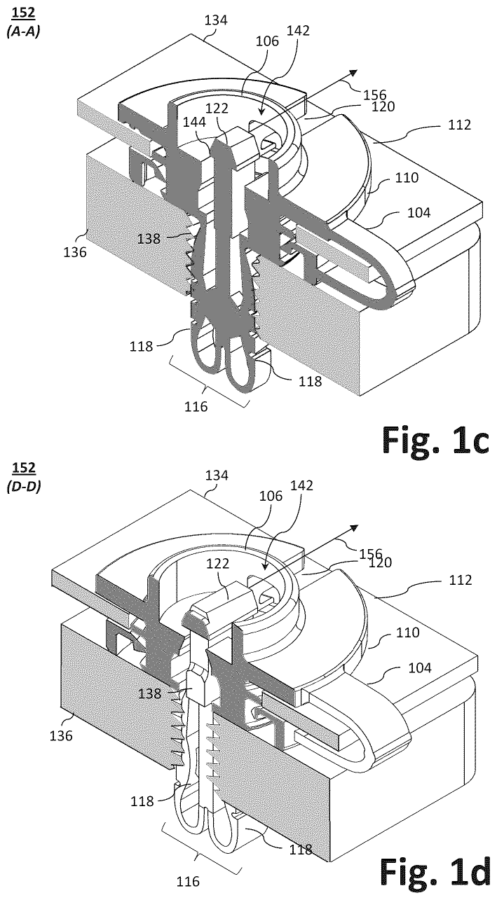

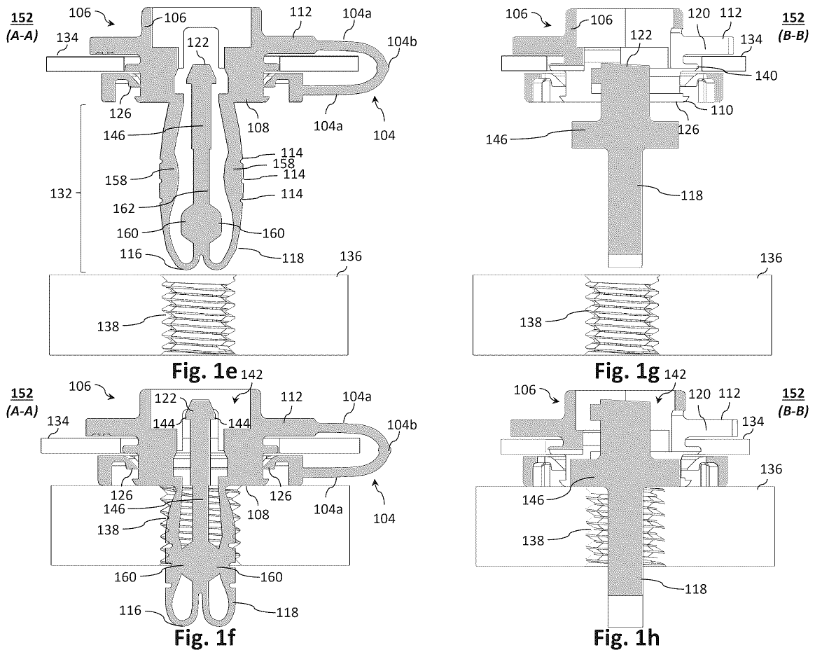

FIGS. 1a through 1h illustrate various views of an edge-fold system 152 incorporating the interlocking fastener 100 in accordance with an aspect of the present disclosure. FIG. 1a shows a perspective view of the edge-fold system 152 with the interlocking fastener 100 in a closed (installed) position. FIGS. 1b through 1d show perspective cross-sectional views taken along cut-lines B-B, A-A, and D-D of FIG. 1a, respectively. FIGS. 1e and 1f illustrate perspective cross-sectional assembly and assembled side elevation views taken along cut-line A-A, while FIGS. 1g and 1h illustrate corresponding assembly and assembled side elevation views taken along cut-line B-B.

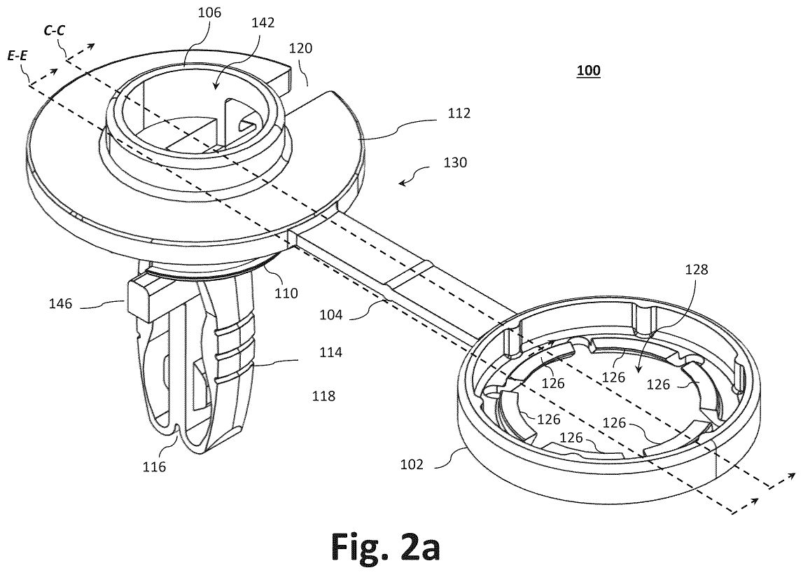

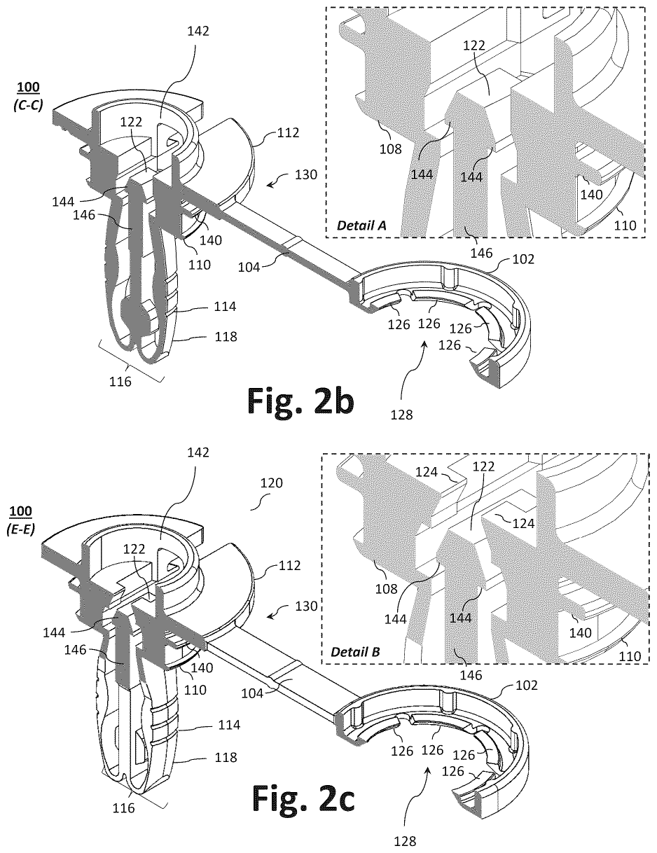

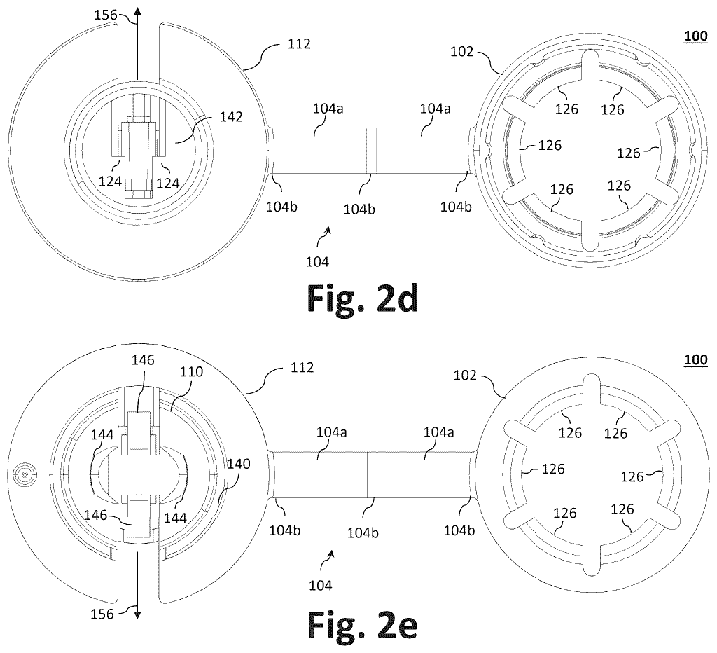

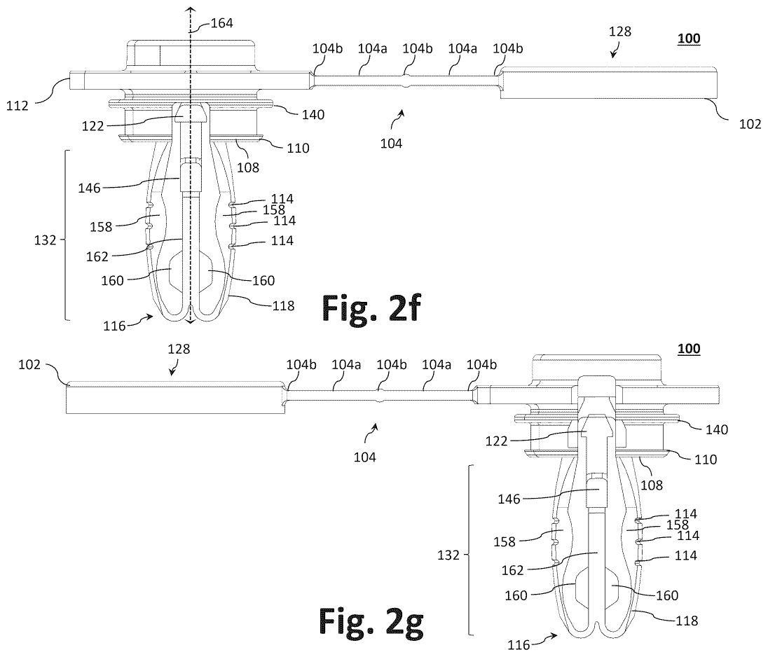

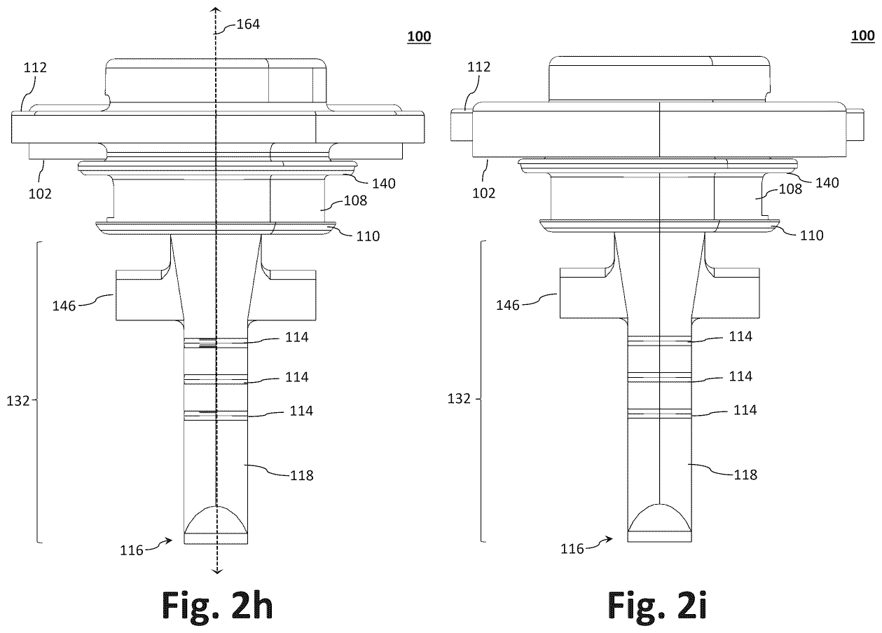

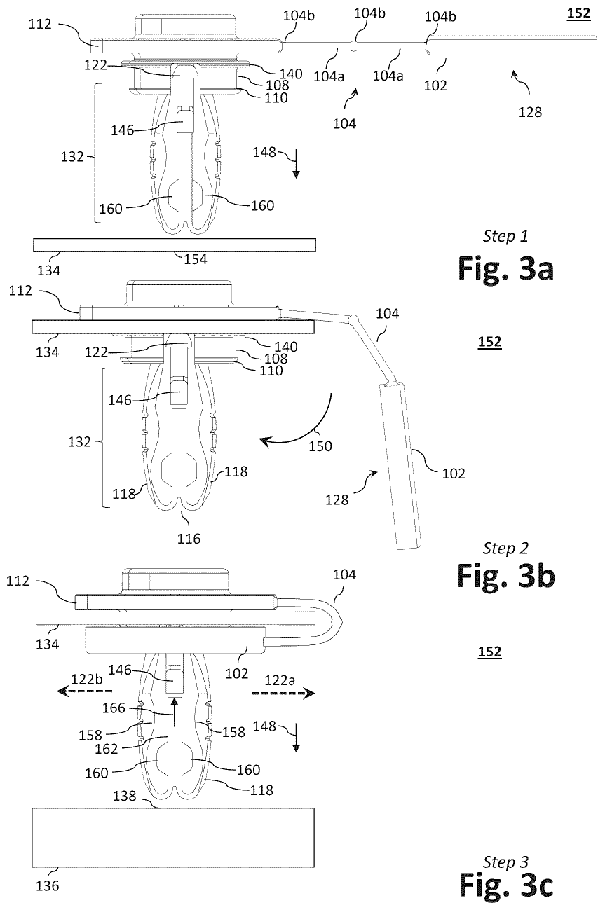

FIGS. 2a through 2i illustrate the interlocking fastener 100 in an open (shipped, uninstalled) position. FIGS. 2a through 2c illustrate perspective and cross-sectional views of the interlocking fastener 100, while FIGS. 2d through 2i illustrate top, bottom, and multiple side elevational views of the interlocking fastener 100. FIGS. 3a through 3c illustrate side elevational views of the edge-fold system 152 during different stages of assembly via an interlocking fastener 100, showing progressive engagement and locking of the interlocking fastener 100 relative to the first component 134 and the second component 136.

The interlocking fastener 100 is configured to fasten a first component 134 relative to a second component 136 via a first component opening 154 and a second component opening 138. In certain examples, the resulting assembly of the interlocking fastener 100 with the first component 134 and the second component 136 is referred to as an edge-fold system 152. As illustrated, during assembly, the interlocking fastener 100 folds over or captures an edge portion of the first component 134 to form a part-in-assembly (PIA) prior to its blind assembly with the second component 136.

The first component 134 may be a flexible sheet or textile material such as cloth, foam, vinyl, fabric, or leather, and may serve as an automotive covering, vapor barrier, or trim layer. The first component 134 includes or otherwise defines the first component opening 154, which can be formed during or after manufacturing of the first component 134. The second component 136 may be a rigid or semi-rigid substrate made from materials such as metal (e.g., aluminum, steel), plastic (e.g., acrylonitrile butadiene styrene (ABS), polycarbonate (PC), or nylon), or composite (e.g., fiberglass-reinforced polymer).

The second component 136 includes or otherwise defines the second component opening 138 formed during manufacturing. The first component opening 154 and the second component opening 138 can be round, though other shapes are contemplated to correspond with the shape of the interlocking fastener 100. As illustrated, the second component opening 138 can be threaded or otherwise textured to increase friction with the interlocking fastener 100.

The interlocking fastener 100 generally includes a retainer 130, a cap 102, and a tether 104 joining the retainer 130 with the cap 102. The retainer 130 generally comprises a collar 106, a retainer body portion 108, and a flange 112, with a fastener portion 132 extending from the retainer 130. The retainer body portion 108 can include a locking feature 110 and a shelf 140. The flange 112 is positioned between the collar 106 and the retainer body portion 108. The retainer 130 defines a passageway 142 having a longitudinal axis 164 that passes through the collar 106, the flange 112, and the retainer body portion 108.

Each portion of the interlocking fastener 100 may be fabricated from polymeric or composite materials such as nylon 6/6, polyoxymethylene (POM, acetal), polypropylene (PP), or glass-fiber-reinforced plastic. In one example, the retainer 130, cap 102, and tether 104 are formed as a unitary molded structure via plastic injection molding. Alternatively, these components may be separately fabricated and joined using ultrasonic welding, thermal staking, or adhesive bonding. In the illustrated embodiment, the tether 104 includes two or more link portions 104a joined to one another and to the retainer 130 and cap 102 via one or more living hinges 104b.

Dimensional tolerances may vary based on application. For example, the retainer body portion 108 may have an outer diameter ranging from about 10 mm to about 40 mm, or approximately 25 mm. The tether 104 may have a flexural thickness of about 0.25 mm to about 2.0 mm, or approximately 0.5-1.0 mm, to permit repeated bending cycles without fatigue. The width of the tether 104 may range from about 2 mm to about 10 mm, or approximately 5 mm. The overall length of the tether 104 may be determined by the distance between the edge of the first component opening 154 and the edge of the first component 134.

The cap 102 defines a cap opening 128 with a plurality of tabs 126 that project inwardly from an annular body of the cap 102 into the cap opening 128. The plurality of tabs 126 are configured to engage a complementary locking feature 110 formed on the retainer body portion 108. When closed, the cap 102 locks onto the retainer 130, clamping the first component 134 between the shelf 140 formed on the retainer body portion 108 and the underside surface of the flange 112. The locking feature 110 may include a chamfered annular ridge that assists in alignment during closure and provides a desired engagement force. The shelf 140 acts as a compression limit stop to prevent overloading or deformation of the first component 134. The spacing between the shelf 140 and flange 112 may approximate the thickness of the first component 134, maintaining a compression tolerance of about 0.3-0.5 mm to ensure consistent clamping pressure without damage. In some examples, when the first component 134 is particularly soft, this spacing may be slightly less than the component's thickness to allow controlled compression.

The retainer 130 includes, extending from its underside, the fastener portion 132. The fastener portion 132 can comprise a pair of resilient retention legs 118 extending downward from the retainer body portion 108. The resilient retention legs 118 are coupled, at proximal ends, to the retainer body portion 108 and joined at their distal ends by a leading end structure 116. The leading end structure 116 may be formed as one or more flexible bridges connecting the retention legs 118.

A post 162 is formed on and extends from the leading end structure 116 between the retention legs 118 and toward the retainer 130 as indicated by arrow 166. The post 162 includes various features configured to cooperate with the retention legs 118 and/or retainer 130, such as one or more buttress features 160, a contact bar 146, and a pin feature 122.

Each retention leg 118 includes one or more outer retention features 114, such as ridges or barbs, configured to grip the inner surface of the sidewall of the second component opening 138 when the fastener is fully seated.

Each retention leg 118 also defines an inner bulbous portion 158 configured to cooperate with buttress features 160 of the post 162. During installation, the retention legs 118 flex radially inward, then return outward once engaged. The post 162 extends axially through the fastener portion 132 and retainer 130, terminating distally in the pin feature 122 and including, along its length, the contact bar 146 and the buttress features 160.

The contact bar 146 is generally perpendicular to the post 162 and configured with a width greater than the second component opening 138 to prevent passage therethrough. The contact bar 146, upon contact with the second component 136, remains stationary relative to the second component 136 during assembly, such that the retainer 130 moves relative to the retention legs 118 and post 162 as the interlocking fastener 100 is seated.

The pin feature 122 defines one or more head ledges 144 that clip or snap into corresponding features of the retainer 130, such as plane features 124 formed in the passageway 142 of the collar 106. During installation, a downward force imparted on the interlocking fastener 100 along the longitudinal axis 164 that drives the post 162 toward and deeper into the retainer 130 (e.g., via the contact bar 146 that abuts the second component 136), causing the buttress features 160 to cam against the bulbous portions 158 of the retention legs 118. This camming action forces the retention legs 118 to flex outward as indicated by arrows 122a and 122b, engaging the sidewalls of the second component opening 138. Once fully engaged, the head ledges 144 of the pin feature 122 snap past the plane features 124 within the retainer 130, thereby automatically assuming a locked condition that restricts reverse movement of the post 162 (e.g., in the direction opposition arrow 166). The amount of pin travel between the open and locked positions may range from approximately 2-15 mm, or approximately 5-10 mm, depending on geometry.

To service or remove the fastener, the pin feature 122 can be urged transversely (relative to the longitudinal axis 164 of the passageway 142) in direction 156. This may be achieved by directly pushing or pulling on the pin feature 122 or by applying a removal force with a release tool. The collar 106 and/or flange 112 may define a slot 120 or similar opening to provide tool or finger access to the pin feature 122. As the pin feature 122 moves in direction 156, the post 162 flexes to allow the head ledges 144 to slide off and clear the plane features 124, allowing the post 162 to move in the opposite direction of insertion. As the post 162 moves, the buttress features 160 disengage from the bulbous portions 158 of the retention legs 118, allowing the legs to return inward and release the second component 136. Because removal is linear and non-rotational, torsional shear and abrasion are avoided, preserving both the fastener and surrounding material.

FIGS. 3a through 3c illustrate an example assembly process. In Step 1, the first component 134 is aligned with the retainer 130 such that the fastener portion 132 is positioned over the first component opening 154. The fastener portion 132 is then inserted through the opening in the direction indicated by arrow 148 until the first component 134 abuts the underside of the flange 112.

In Step 2, the cap 102 is pivoted as indicated by arrow 150 relative to the retainer 130 via the tether 104. The tether 104 flexes at its living hinges 104b, allowing the cap 102 to pass over the leading end structure 116 and along the fastener portion 132 until the fastener portion passes through the cap opening 128. The cap 102 is then pressed toward the retainer 130 until the tabs 126 engage the locking feature 110, clamping the first component 134 in place. The first component 134 and the interlocking fastener 100 can be shipped, if desired, as a pre-installed part-in-assembly.

In Step 3, the combined interlocking fastener 100 and first component 134 are positioned relative to the second component 136. The fastener portion 132 is inserted through the second component opening 138 until the underside of the cap 102 contacts the upper surface of the second component 136. Continued insertion forces the retainer 130 downward, causing the contact bar 146 on the post 162 to engage the second component 136. As the retainer 130 moves further downward, the stationary post 162 advances relative to the retainer, driving the pin feature 122 and expanding the retention legs 118 outward until the pin feature 122 snaps past the plane features 124. The interlocking fastener 100 is then fully locked in position.

For removal, the pin feature 122 is urged transversely to slide the head ledges 144 off the plane features 124, releasing the post 162 from the retainer 130. This disengages the buttress features 160 from the bulbous portions 158, allowing the retention legs 118 to relax inward for withdrawal. The interlocking fastener 100 thus provides a reusable and serviceable fastening solution suitable for joining soft and rigid materials in automotive, aerospace, and consumer product applications. The integrated pin feature 122, buttress features 160, and resilient retention legs 118 enable controlled, repeatable engagement and disengagement without performance degradation. The result is a robust, modular fastening system that combines ease of assembly, reusability, and mechanical reliability in both through-hole and blind-hole applications.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. An interlocking fastener comprising:
a retainer portion defining a passageway extending along a longitudinal axis; and
a fastener portion including a shaft extending along the longitudinal axis and a pin feature at a distal end of the shaft,
wherein the pin feature is configured to snap into the retainer portion when the pin feature and the retainer portion are moved toward one another linearly along the longitudinal axis, and
wherein the pin feature is configured to be released from the retainer portion when the pin feature is urged transversely relative to the longitudinal axis to disengage the pin feature from the retainer portion.

2. The interlocking fastener of claim 1, wherein the retainer portion includes one or more plane features or recesses configured to receive and retain corresponding head ledges formed on the pin feature when snapped together.

3. The interlocking fastener of claim 2, wherein urging the pin feature transversely relative to the longitudinal axis allows the head ledges to clear the plane features, thereby permitting the shaft to be withdrawn from the retainer portion.

4. The interlocking fastener of claim 1, wherein the fastener portion further comprises a pair of retention legs, wherein the shaft extends between the pair of retention legs.

5. The interlocking fastener of claim 4, wherein movement of the retainer portion and the fastener portion toward one another along the longitudinal axis causes one or more buttress features on the shaft to cam against the retention legs to urge the retention legs radially outward from the longitudinal axis.

6. The interlocking fastener of claim 1, wherein the fastener portion further comprises a contact bar configured to engage a surface of a component during installation to facilitate relative movement between the shaft and the retainer portion.

7. An interlocking fastener for securing a first component to a second component, the interlocking fastener comprising:
a retainer defining a passageway having a longitudinal axis and including a retainer body portion and a fastener portion,
wherein the fastener portion comprises a pair of resilient retention legs extending from the retainer body portion and joined at distal ends by a leading end structure, and
wherein each of the retention legs includes an outer retention feature and an inner bulbous portion;
a post extending from the leading end structure toward the retainer body portion and between the pair of resilient retention legs,
wherein the post includes one or more buttress features configured to engage the inner bulbous portions of the retention legs; and
a pin feature positioned at a distal end of the post and configured to snap into the retainer body portion.

8. The interlocking fastener of claim 7, wherein the pin feature includes one or more head ledges configured to cooperatively retain the post in a locked position within the retainer.

9. The interlocking fastener of claim 8, wherein the pin feature is configured to translate along the longitudinal axis to extend into and engage a feature in the passageway.

10. The interlocking fastener of claim 9, wherein the feature is a plane feature defined by the retainer body portion.

11. The interlocking fastener of claim 10, wherein urging the pin feature transversely relative to the longitudinal axis releases the head ledges from the plane features, thus disengaging the pin feature from the retainer body portion.

12. The interlocking fastener of claim 7, wherein movement of the post and the retainer body portion toward one another along the longitudinal axis causes the buttress features to cam against the inner bulbous portions to urge the retention legs radially outward from the longitudinal axis into engagement with the second component.

13. The interlocking fastener of claim 12, wherein movement of the post and the retainer body portion away from one another along the longitudinal axis allows the retention legs to disengage the second component.

14. The interlocking fastener of claim 7, further comprising:
a cap defining a cap opening and having a plurality of locking tabs configured to engage a locking feature on the retainer; and
a tether joining the cap to the retainer, the tether comprising at least one living hinge and one or more link portions,
wherein the cap is configured to flex via the tether to move relative to the retainer between an open position and a closed position, and
wherein, in the closed position, the locking tabs engage the locking feature to secure the first component between a shelf formed on the retainer and an underside of the cap.

15. The interlocking fastener of claim 7, further comprising a contact bar is generally perpendicular to the longitudinal axis and configured to abut the second component opening during assembly to move the post and the retainer body portion toward one another along the longitudinal axis.
